(19) United States
(12) Patent Application Publication
(10) Pub. No.: US 2006/0167961 A1
(43) Pub. Date: Jul. 27, 2006

(54) Autonomic cache object array based on heap usage

(75) Inventor: James Edward Fox, Apex, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/044,970

(22) Filed: Jan. 27, 2005

(51) Int. Cl. G06F 17/30

(52) U.S. Cl. 707/206

(57) ABSTRACT

A method, apparatus and computer instructions for automatically regulating a cache object array based on the amount of available heap. The free space of the heap is determined after each garbage collection cycle and the amount of space allocated for cache object array growth is adjusted accordingly. Additionally, a default allocation of available space to cache object array growth is provided at system startup. Also, monitoring cache object array growth is provided and entries are removed from the cache object array in response to cache object array growth exceeding the allocated percentage of the available space.

### BACKGROUND OF THE INVENTION

1. Technical Field

The present invention is generally directed to an improved data processing system. More specifically, the present invention is directed to automatically regulating a cache object array based on the amount of available heap.

2. Description of Related Art

The memory utilization of a Java™ heap is an important characteristic of program performance. Whenever a class instance or array is created in a running Java™ application, the memory of the new cache object is allocated from a single heap. Because a Java™ application runs inside its “own” exclusive Java Virtual Machine (JVM™) instance, a separate heap exists for every individual running application. As only one heap exists inside a JVM™ instance, all threads share it.

A “new” construct in Java™ is supported in the JVM™ by allocating memory on the heap for a new cache object. The allocation of memory dedicated to object caching is performed by a user and requires the user to have some basic knowledge of cache tuning. Also, the allocation of the memory dedicated to object caching is static until the user decides to change the size of the allocation. Thus, the virtual machine itself is responsible for deciding whether and when to free memory occupied by cache objects that are no longer referenced by the running application due to the defined cache object space. Usually, a JVM™ implementation uses a garbage collector to manage the heap and clean up the heap, i.e. identify cache objects that no longer have active references in the running application to them and free the memory associated with these “dead” cache objects.

The garbage collector's primary function is to automatically reclaim the memory used by objects that are no longer reference by the running application. It also can move objects as the application runs to reduce heap fragmentation. The memory that makes up the heap need not be contiguous and can be expanded and contracted as the running program progresses and the space allocated for cached object does not change as the allocation is set by the user.

Even though the heap is a limited resource, the amount of space allocated to object caching may be manually changed based upon heap usage. Actual changing of the space allocated to object caching requires a user to know the requirements of heap sizing, garbage collecting and cache tuning. Thus, it would be advantageous to have a method and system for automatically regulating a cache object array based on the amount of available heap.

### BRIEF SUMMARY OF THE INVENTION

The present invention provides a method, system and computer instructions for automatically regulating a cache object array based on the amount of free continuous space within the heap. Within the present invention, the free space of the heap is determined after each garbage collection cycle and the amount of space allocated for cache object growth is regulated accordingly.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a distributed data processing system in which aspects of the present invention may be implemented;

FIG. 2 is an exemplary diagram of a server computing system in which aspects of the present invention may be implemented;

FIG. 3 is an exemplary diagram of a client computing system in which aspects of the present invention may be implemented;

FIG. 4A is an exemplary diagram illustrating the relationship of software components operating within a computer system that may implement aspects of the present invention;

FIG. 4B is an exemplary block diagram of a JVM™ is depicted in accordance with a preferred embodiment of the present invention;

FIG. 5, an exemplary block diagram in which a memory management processor manages memory space within the memory allocated to heap in accordance with a preferred embodiment of the present invention;

FIG. 6 is an exemplary table of heap allocation in accordance with a preferred embodiment of the present invention; and

FIG. 7 is an exemplary flow diagram illustrating the operation of automatically regulating a cache object array based on the amount of available heap in accordance with a preferred embodiment of the present invention.

### DETAILED DESCRIPTION OF THE INVENTION

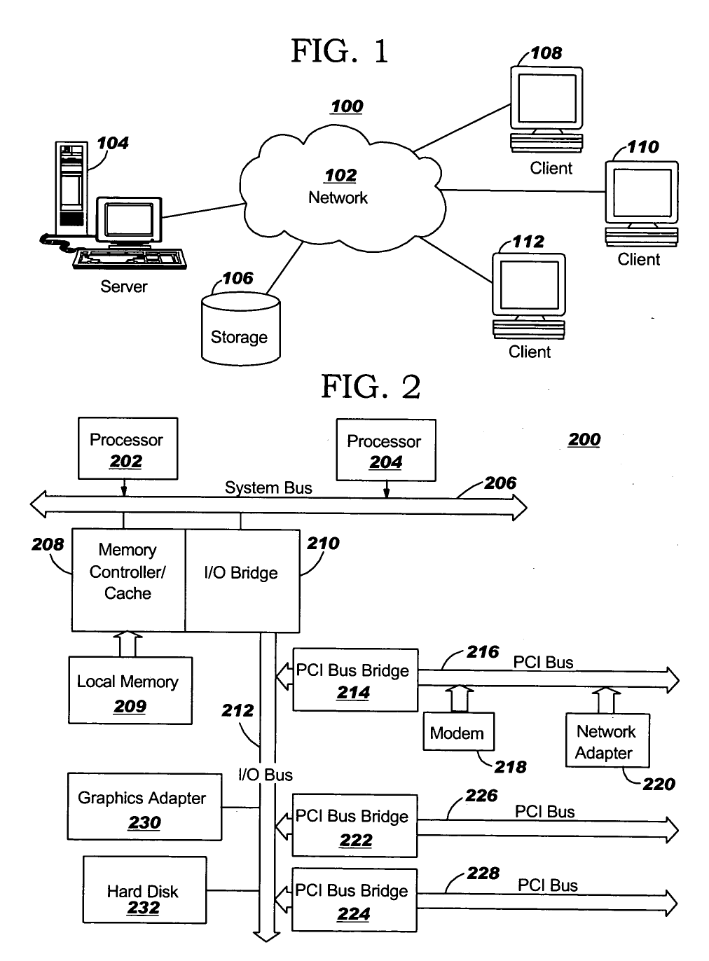

The present invention is directed to automatically regulating a cache object array based on the amount of available heap. The present invention is preferably used with computing devices that are part of a distributed data processing environment, such as the Internet, a wide area network (WAN), local area network (LAN), or the like, but is not limited to such and may be used in a stand-alone computing system or completely within a single computing device. The following FIGS. 1-3 are intended to provide a context for the description of the mechanisms and operations performed by the present invention. The systems and computing environments described with reference to FIGS. 1-3 are intended to only be exemplary and are not intended to assert or imply any limitation with regard to the types of computing system and environments in which the present invention may be implemented.

With reference now to the figures, FIG. 1 depicts a pictorial representation of a network of data processing systems in which the present invention may be implemented in accordance with a preferred embodiment of the present invention. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pseries® system, a product of International Business Machines Corporation in Armonk, N.Y., running the Advanced Interactive Executive (AIX™) operating system or LINUX operating system.

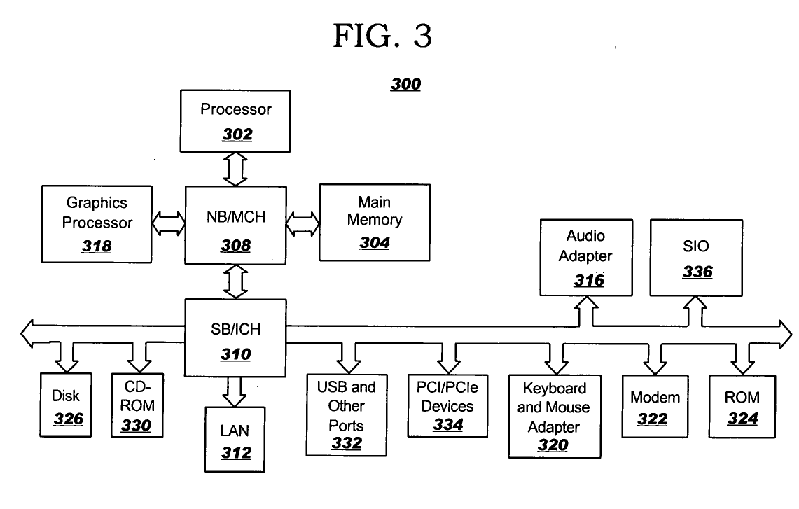

With reference now to FIG. 3, a block diagram of a data processing system is shown in which the present invention may be implemented in accordance with a preferred embodiment of the present invention. Data processing system 300 is an example of a computer, such as client 108 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300 in FIG. 3. The operating system may be a commercially available operating system such as Windows XP™, which is available from Microsoft Corporation. An object oriented programming system, such as the Java™ programming system, may run in conjunction with the operating system and provides calls to the operating system from Java™ programs or applications executing on data processing system 300. “Java” is a trademark of Sun Microsystems, Inc.

Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

For example, data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

Although the present invention may operate on a variety of computer platforms and operating systems, it may also operate within an interpretive environment, such as a REXX™, Smalltalk™, or Java™ runtime environment, and the like. For example, the present invention may operate in conjunction with a Java Virtual Machine (JVM™) yet within the boundaries of a JVM™ as defined by Java™ standard specifications. In order to provide a context for the present invention with regard to an exemplary interpretive environment, portions of the operation of a JVM™ according to Java™ specifications are herein described.

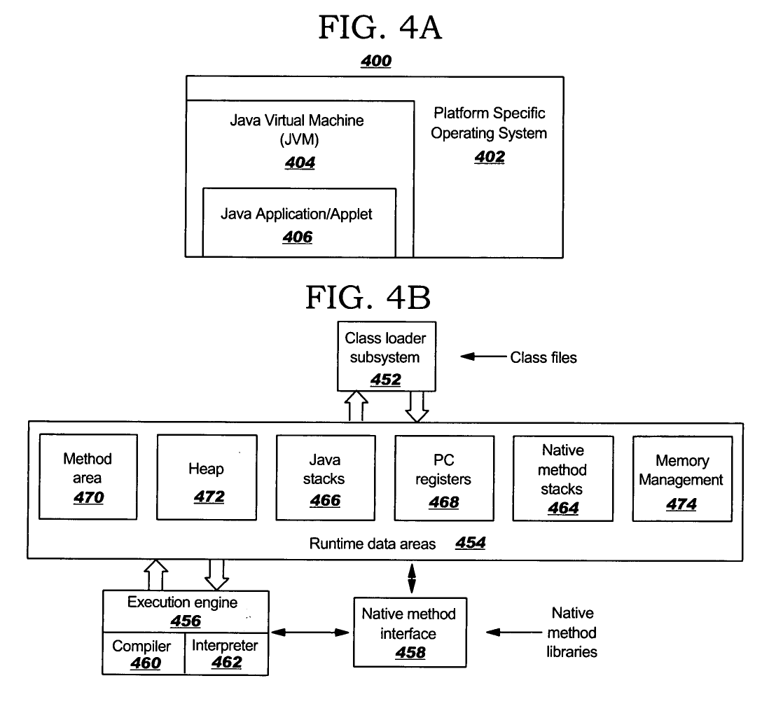

With reference now to FIG. 4A, a block diagram illustrates the relationship of software components operating within a computer system that may implement the processes of the present invention in accordance with a preferred embodiment of the present invention. Java™-based system 400 contains platform specific operating system 402 that provides hardware and system support to software executing on a specific hardware platform. JVM™ 404 is one software application that may execute in conjunction with the operating system. Alternatively, JVM™ 404 may be imbedded inside a Java™ enabled browser application such as Microsoft Internet Explorer™ or Netscape Communicator™. JVM™ 404 provides a Java™ run-time environment with the ability to execute Java™ application or applet 406, which is a program, servlet, or software component written in the Java™ programming language. The computer system in which JVM™ 404 operates may be similar to data processing system 200 or computer 100 described above. However, JVM™ 404 may be implemented in dedicated hardware on a so-called Java™ chip or Java™ processor with an embedded picoJava™ core. At the center of a Java™ run-time environment is the JVM™, which supports all aspects of Java™'s environment, including its architecture, security features, mobility across networks, and platform independence.

The JVM™ is a virtual computer, i.e. a computer that is specified abstractly. The specification defines certain features that every JVM™ must implement, with some range of design choices that may depend upon the platform on which the JVM™ is designed to execute. For example, all JVM™s must execute Java™ bytecodes and may use a range of techniques to execute the instructions represented by the bytecodes. A JVM™ may be implemented completely in software or somewhat in hardware. This flexibility allows different JVM™S to be designed for mainframe computers and PDAs.

The JVM™ is the name of a virtual computer component that actually executes Java™ programs. Java™ programs are not run directly by the central processor but instead by the JVM™, which is itself a piece of software running on the processor. The JVM™ allows Java™ programs to be executed on a different platform as opposed to only the one platform for which the code was compiled. Java™ programs are compiled for the JVM™. In this manner, Java™ is able to support applications for many types of data processing systems, which may contain a variety of central processing units and operating systems architectures. To enable a Java™ application to execute on different types of data processing systems, a compiler typically generates an architecture-neutral file format—the compiled code is executable on many processors, given the presence of the Java™ run-time system.

The Java™ compiler generates bytecode instructions that are nonspecific to a particular computer architecture. A bytecode is a machine independent code generated by the Java™ compiler and executed by a Java™ interpreter. A Java™ interpreter is part of the JVM™ that alternately decodes and interprets a bytecode or bytecodes. These bytecode instructions are designed to be easy to interpret on any computer and easily translated on the fly into native machine code.

A JVM™ must load class files and execute the bytecodes within them. The JVM™ contains a class loader, which loads class files from an application and the class files from the Java™ application programming interfaces (APIs) which are needed by the application. The execution engine that executes the bytecodes may vary across platforms and implementations.

One type of software-based execution engine is a just-in-time (JIT) compiler. With this type of execution, the bytecodes of a method are compiled to native machine code upon successful fulfillment of some type of criteria for “jitting” a method. The native machine code for the method is then cached and reused upon the next invocation of the method. The execution engine may also be implemented in hardware and embedded on a chip so that the Java™ bytecodes are executed natively. JVM™s usually interpret bytecodes, but JVM™s may also use other techniques, such as just-in-time compiling, to execute bytecodes.

When an application is executed on a JVM™ that is implemented in software on a platform-specific operating system, a Java™ application may interact with the host operating system by invoking native methods. A Java™ method is written in the Java™ language, compiled to bytecodes, and stored in class files. A native method is written in some other language and compiled to the native machine code of a particular processor. Native methods are stored in a dynamically linked library whose exact form is platform specific.

With reference now to FIG. 4B, a block diagram of a JVM™ is depicted in accordance with a preferred embodiment of the present invention. JVM™ 450 includes a class loader subsystem 452, which is a mechanism for loading types, such as classes and interfaces, given fully qualified names. JVM™ 450 also contains runtime data areas 454, execution engine 456, native method interface 458, and memory management 474. Execution engine 456 is a mechanism for executing instructions contained in the methods of classes loaded by class loader subsystem 452. Execution engine 456 may be, for example, Java™ interpreter 462 or just-in-time compiler 460. Native method interface 458 allows access to resources in the underlying operating system. Native method interface 458 may be, for example, a Java™ native interface.

Runtime data areas 454 contain native method stacks 464, Java™ stacks 466, PC registers 468, method area 470, and heap 472. These different data areas represent the organization of memory needed by JVM™ 450 to execute a program.

Java™ stacks 466 are used to store the state of Java™ method invocations. When a new thread is launched, the JVM™ creates a new Java™ stack for the thread. The JVM™ performs only two operations directly on Java™ stacks: it pushes and pops frames. A thread's Java™ stack stores the state of Java™ method invocations for the thread. The state of a Java™ method invocation includes its local variables, the parameters with which it was invoked, its return value, if any, and intermediate calculations. Java™ stacks are composed of stack frames. A stack frame contains the state of a single Java™ method invocation. When a thread invokes a method, the JVM™ pushes a new frame onto the Java™ stack of the thread. When the method completes, the JVM™ POPS the frame for that method and discards it.

The JVM™ does not have any registers for holding intermediate values; any Java™ instruction that requires or produces an intermediate value uses the stack for holding the intermediate values. In this manner, the Java™ instruction set is well-defined for a variety of platform architectures.

PC registers 468 are used to indicate the next instruction to be executed. Each instantiated thread gets its own pc register (program counter) and Java™ stack. If the thread is executing a JVM™ method, the value of the pc register indicates the next instruction to execute. If the thread is executing a native method, then the contents of the pc register are undefined.

Native method stacks 464 store the state of invocations of native methods. The state of native method invocations is stored in an implementation-dependent way in native method stacks, registers, or other implementation-dependent memory areas. In some JVM™ implementations, native method stacks 464 and Java™ stacks 466 are combined.

Method area 470 contains class data while heap 472 contains all instantiated objects. The JVM™ specification strictly defines data types and operations. Most JVM™s choose to have one method area and one heap, each of which are shared by all threads running inside the JVM™. When the JVM™ loads a class file, it parses information about a type from the binary data contained in the class file. It places this type information into the method area. Each time a class instance or array is created, the memory for the new object is allocated from heap 472. JVM™ 450 includes an instruction that allocates memory space within the memory for heap 472 but includes no instruction for freeing that space within the memory. Memory management 474 in the depicted example manages memory space within the memory allocated to heap 470. Memory management 474 may include a garbage collector which automatically reclaims memory used by objects that are no longer referenced. Additionally, a garbage collector also may move objects to reduce heap fragmentation.

The garbage collector performs operations generally referred to as mark/sweep/compact. These operations are the marking of live objects and coalescing sequences of dead objects and spaces that are not marked as live to thereby free or reclaim memory space. Any fragmentation caused by the live objects within the heap is compacted during the compact operation. Compaction moves objects toward one end of the heap with the goal of creating the largest possible contiguous free area or areas. Compaction helps to avoid allocating new memory to expand the heap size. More information about garbage collection may be found in Dimpsey et al., “Java™ Server Performance: A Case Study of Building Efficient, Scalable JVM™s,” IBM System's Journal, January 2000, which is hereby incorporated by reference.

Thus, the present invention provides for automatically regulating a cache object array based on the amount of free continuous space within the heap. Within the present invention, the free space of the heap is determined after each garbage collection cycle and the amount of space allocated for cache object growth is regulated accordingly.

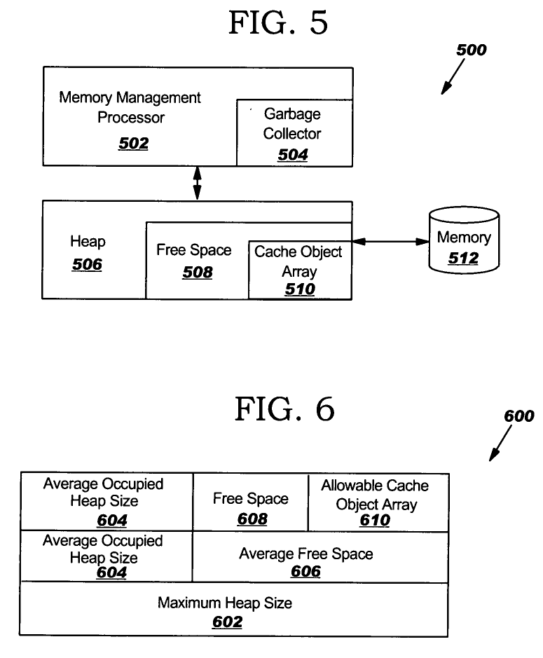

With reference now to FIG. 5, block diagram of object management system 500 is shown in which a memory management processor manages memory space within the memory allocated to heap in accordance with a preferred embodiment of the present invention. Memory management processor 502 includes garbage collector 504, which automatically reclaims memory used by objects that are no longer referenced within heap 506. Memory management processor 502 corresponds to the memory management 474 and heap 506 corresponds to heap 472 of FIG. 4. As the garbage collector 504 moves objects to reduce heap 506 fragmentation, free space 508 is created within the maximum heap size allocation. Within the free space 508 an object caching array 510 is allocated to provide object caching. Object caching array 510 is available to the user for storage of live referenced objects, such as frequently referenced application data. The referenced application data may be any data run by application 406 of FIG. 4 on server 104 or clients 108, 110 and 112 of FIG. 1. Heap 506, free space 508 and object cache array 510 are within system memory 512 which corresponds to memory controller/cache 208 of FIG. 2. Thus, the present invention allows the memory management processor 502 to regulate the allocation of object cache array 510 based on the size of heap 502.

The illustrative examples of the present invention make use of the mark and sweep operations of garbage collection to identify the free space within the heap allocation. FIG. 6 is an exemplary table of heap allocation in accordance with a preferred embodiment of the present invention. In FIG. 6, the average occupied heap size 604 is shown after garbage collection has run and is shown as 50 percent of maximum heap size 602 and, thus, the average free space 606 is the other 50 percent. The present invention then allows the allocation of the allowable cache object array 610 to be 50 percent of the average free space 606 which makes the allowable cache object array 610 to be 25 percent of the maximum heap size 602. However, the allowable cache object array 610 may grow to consume more than 50 percent of the average free space 606 and there would be impact due to excessive compaction as garbage collection tries to allocate contiguous space. Thus, the present invention may make use of maximum parameter rules which may be, for example, allocating up to 50 percent of average free space 606 after garbage collection, not more than 25 percent of the maximum heap size 602, or enabling a ceiling of not more than 25 percent of the maximum heap size 602 which would all prevent excessive allocation. The illustrated percentages are for example only and other percentages may be used.

For example, if the average occupied heap size 604 is shown after garbage collection has run and is shown as 66 percent of maximum heap size 602 and, thus, the average free space 606 is the other 34 percent. The present invention then allows the allocation of the allowable cache object array 610 to be 50 percent of the average free space 606 which makes the allowable cache object array 610 to be 17 percent of the maximum heap size 602. Thus the present invention allows for regulation of cache object array 610 depending on heap size 602.

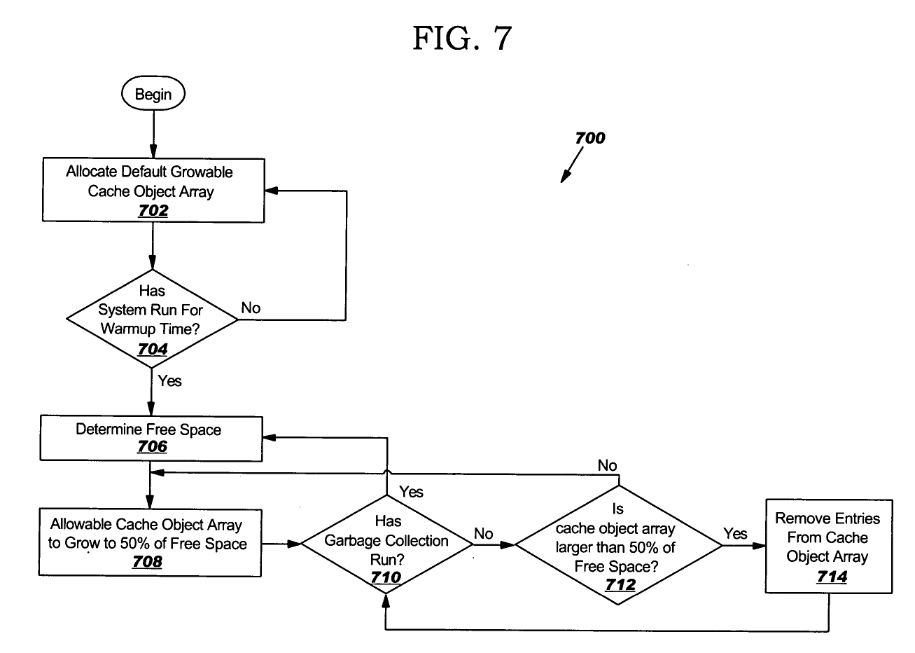

In FIG. 7, flowchart 700 illustrates an exemplary operation of automatically regulating a cache object array based on the amount of available heap in accordance with a preferred embodiment of the present invention. With relation to FIG. 5, as the operation begins, the system is booting up and garbage collection process 506 has not run. As the memory management processor 502 begins to process data, heap 506 begins to grow in size. Then the memory management processor 502 implements an operation as a preferred embodiment of the present invention.

The preferred operation of the present invention begins by allocating a default cache object array (block 702). The cache object array represents a typical FIFO type array, such as session data. The default allocation of the cache object array may be, for example, a minimum size of 10 megabytes and a maximum size of 25 percent of maximum heap size or 50 percent of average free space. A decision is then made as to whether the system has run for a predefined amount of time (block 704). The predefined amount of time is for the computer to warm-up and the processes running on the computer to stabilize. This time may be, for example, one hour or another time that is known by the user as an average of time it takes the system to warm-up. If the system has not run for the predetermined time, the allocation for the cache object array is maintained at the default settings. If the system has run for the predetermined amount of time and the heap has started to stabilize, the average free space of the heap is determined (block 706). The average free space is determined by the subtracting the average occupied heap size after garbage collection from the maximum heap size specified by the user. Based on the average free space, the cache object array is allowed add more objects into the array and grow to 50 percent of the average free space (block 708). At block 710, a determination of whether garbage collection has run. If so, the operation returns to block 706 and the average free space is again determined and based on the average free space, the cache object array is allowed add more objects into the array and grow to 50 percent of the average free space (block 708). If at block 710, garbage collection has not run then a determination of the size of the cache object array is made (block 712). If the cache object array is not larger than 50 percent of the average free space, the operation returns to block 708 and the cache object array is allowed to grow up to 50 percent of the average free space. If at block 712 the cache object array is larger than 50 percent of the average free space, entries are removed from the cache object array until the size is below 50 percent of the average free space and the process returns to block 710. One method to remove cached objects from the array would be to perform a standard FIFO cleanup.

Thus, the present invention provides mechanisms for automatically regulating a cache object array based on the amount of available heap. As a result, the cache object array size changes automatically with changes in the heap size and free space. The present invention avoids a user having to understand cache tuning and manually change cache object array size when needed.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Though the examples presented are directed toward Java applications, the present invention may be applied to other programming environments that use heaps. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing a heap, the method comprising:
determining available space within the heap, wherein the heap includes a cache object array;
allocating a percentage of the available space to the cache object array;
determining an event within the system;
determining new available space based on the event; and
regulating the percentage of available space to the cache object array based on the new available space.

2. The method of claim 1, wherein the event is garbage collection.

3. The method of claim 1, wherein the available space is available free space.

4. The method of claim 1, wherein the cache object array is regulated automatically.

5. The method of claim 1, further comprising:
allocating a default percentage of the available space to cache object array growth at system startup.

6. The method of claim 5, wherein the default percentage is based on at least one of allocating a percentage of available free space within the heap, allocating not more than a percentage of the maximum heap size, and allocating based on a ceiling of not more than percentage of the maximum heap size.

7. The method of claim 1, wherein determining available space within a heap is done after a predetermined time from system startup.

8. The method of claim 1, further comprising:
monitoring cache object array growth; and
removing entries from the cache object array in response to cache object array growth exceeding the allocated percentage of the available space.

9. The method of claim 8, wherein removing entries from the cache object array is performed using standard FIFO cleanup.

10. A data processing system comprising:
a bus system;
a communications system connected to the bus system;
a memory connected to the bus system, wherein the memory includes a set of instructions; and
a processing unit connected to the bus system, wherein the processing unit executes the set of instructions to determine available space within the heap, wherein the heap includes a cache object array; allocate a percentage of the available space to the cache object array; determine an event within the system; determine new available space based on the event; and regulate the percentage of available space to the cache object array based on the new available space.

11. The data processing system of claim 10, wherein the event is garbage collection.

12. The data processing system of claim 10, wherein the available space is available free space.

13. The data processing system of claim 10, wherein the cache object array is regulated automatically.

14. The data processing system of claim 10, further comprising:
a set of instructions to allocate a default percentage of the available space to cache object array growth at system startup.

15. The data processing system of claim 14, wherein the default percentage is based on at least one of allocating a percentage of available free space within the heap, allocating not more than a percentage of the maximum heap size, and allocating based on a ceiling of not more than percentage of the maximum heap size.

16. The data processing system of claim 10, wherein determining available space within a heap is done after a predetermined time from system startup.

17. The data processing system of claim 10, further comprising:
a set of instructions to monitor cache object array growth; and remove entries from the cache object array in response to cache object array growth exceeding the allocated percentage of the available space.

18. The data processing system of claim 17, wherein removing entries from the cache object array is performed using standard FIFO cleanup.

19. A computer program product in a computer readable medium for managing a heap, comprising:
instructions for determining available space within the heap, wherein the heap includes a cache object array;
instructions for allocating a percentage of the available space to the cache object array;
instructions for determining an event within the system;
instructions for determining new available space based on the event; and
instructions for regulating the percentage of available space to the cache object array based on the new available space.

20. The computer program product of claim 19, wherein the event is garbage collection.

21. The computer program product of claim 19, wherein the available space is available free space.

22. The computer program product of claim 19, wherein the cache object array is regulated automatically.

23. The computer program product of claim 19, further comprising:
instructions for allocating a default percentage of the available space to cache object array growth at system startup.

24. The computer program product of claim 23, wherein the default percentage is based on at least one of allocating a percentage of available free space within the heap, allocating not more than a percentage of the maximum heap size, and allocating based on a ceiling of not more than percentage of the maximum heap size.

25. The computer program product of claim 19, wherein determining available space within a heap is done after a predetermined time from system startup.

26. The computer program product of claim 19, further comprising:
instructions for monitoring cache object array growth; and
instructions for removing entries from the cache object array in response to cache object array growth exceeding the allocated percentage of the available space.

27. The computer program product of claim 26, wherein removing entries from the cache object array is performed using standard FIFO cleanup.

28. An apparatus for managing a heap, comprising:
determining means for determining available space within the heap, wherein the heap includes a cache object array;
allocating means for allocating a percentage of the available space to the cache object array;
determining means for determining an event within the system;
determining means for determining new available space based on the event; and
regulating means for regulating the percentage of available space to the cache object array based on the new available space.

29. The apparatus of claim 28, further comprising:
allocating means for allocating a default percentage of the available space to cache object array growth at system startup.

30. The apparatus of claim 28, further comprising:
monitoring means for monitoring cache object array growth; and
removing means for removing entries from the cache object array in response to cache object array growth exceeding the allocated percentage of the available space.
